(19) United States
(12) Patent Application Publication
(10) Pub. No.: US 2015/0336514 A1
(43) Pub. Date: Nov. 26, 2015

(54) TOOL FOR SELECTIVE ATTACHMENT TO A VEHICLE

(71) Applicants: Vernon Dwight Brown, JR., Ormond Beach, FL (US); Cynthia Brown, Ormond Beach, FL (US)

(72) Inventors: Vernon Dwight Brown, JR., Ormond Beach, FL (US); Cynthia Brown, Ormond Beach, FL (US)

(21) Appl. No.: 14/286,390

(22) Filed: May 23, 2014

(51) Int. Cl. B60R 11/00

(52) U.S. Cl. CPC B60R 11/00

(57) ABSTRACT

A tool for selective attachment to a vehicle may be provided. The tool may include a shell having a substantially rectangular cross-section, such that the shell includes a top panel, a bottom panel, a first side panel, and a second side panel. A cavity may be defined between the top panel, the bottom panel, the first panel and the second panel. The tool may further include a table having a substantially planar top surface, and the table may be at least partially disposed within the cavity and slidable relative to the cavity.

### BACKGROUND

A user of a vehicle may wish to have reliable access to a table. In particular, a person that uses a truck with a bed for carrying cargo may wish to provide a portable table in the bed of the truck for purposes such as work, eating, or any other purpose. However, conventional portable tables may occupy valuable space and may be ill-suited to support loads when other cargo must be transported. Additionally, conventional portable tables may be unsecured relative to the vehicle, allowing the table to shift undesirably during operation of the vehicle.

Tables may be secured to the bed of a truck such that the shifting problem may be relieved. However, these tables may be permanently affixed to the truck such that they are time-consuming to install, remove, or transfer to another vehicle. Moreover, known securable tables may have relatively complicated mechanical components that increase the cost of the devices while reducing their capacity to reliably support heavy loads.

### SUMMARY

In one exemplary embodiment, a tool for selective attachment to a vehicle may be provided. The tool may include a shell having a substantially rectangular cross-section, such that the shell includes a top panel, a bottom panel, a first side panel, and a second side panel. A cavity may be defined between the top panel, the bottom panel, the first panel and the second panel. The tool may further include a table having a substantially planar top surface, and the table may be at least partially disposed within the cavity and slidable relative to the cavity.

In another exemplary embodiment, a tool for selective attachment to a vehicle may be provided. The tool may include a shell having a substantially rectangular cross-section, such that the shell includes a top panel, a bottom panel, a first side panel, and a second side panel. A cavity may be defined between the top panel, the bottom panel, the first panel and the second panel. The tool may further include a table having a substantially planar top surface, and the table may be at least partially disposed within the cavity and slidable relative to the cavity. There may be at least one support beam coupled to the bottom surface of the table. The top panel of the shell may be configured to flex such that a bottom surface of the top panel may directly contact the top surface of the table. When a load is applied to the top panel, at least a portion of the weight of the load may be directly transferred to the table via the direct contact between the bottom surface of the top panel and the top surface of the table.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

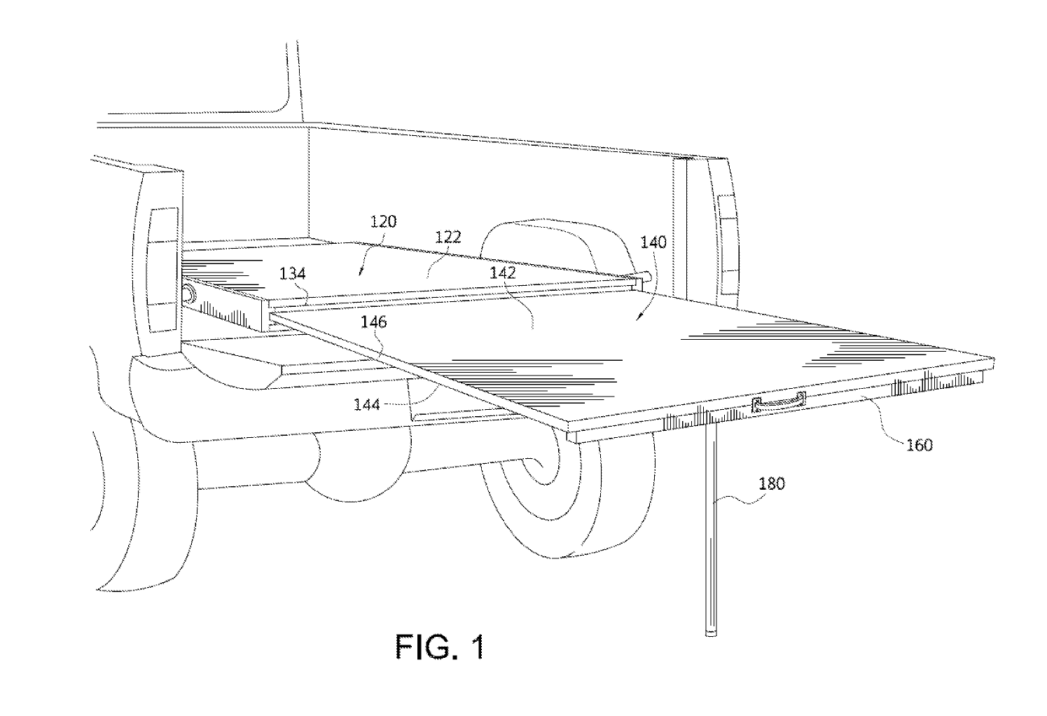

Exemplary FIG. 1 may depict an embodiment of a tool for selective attachment to a vehicle with a table in an extended position.

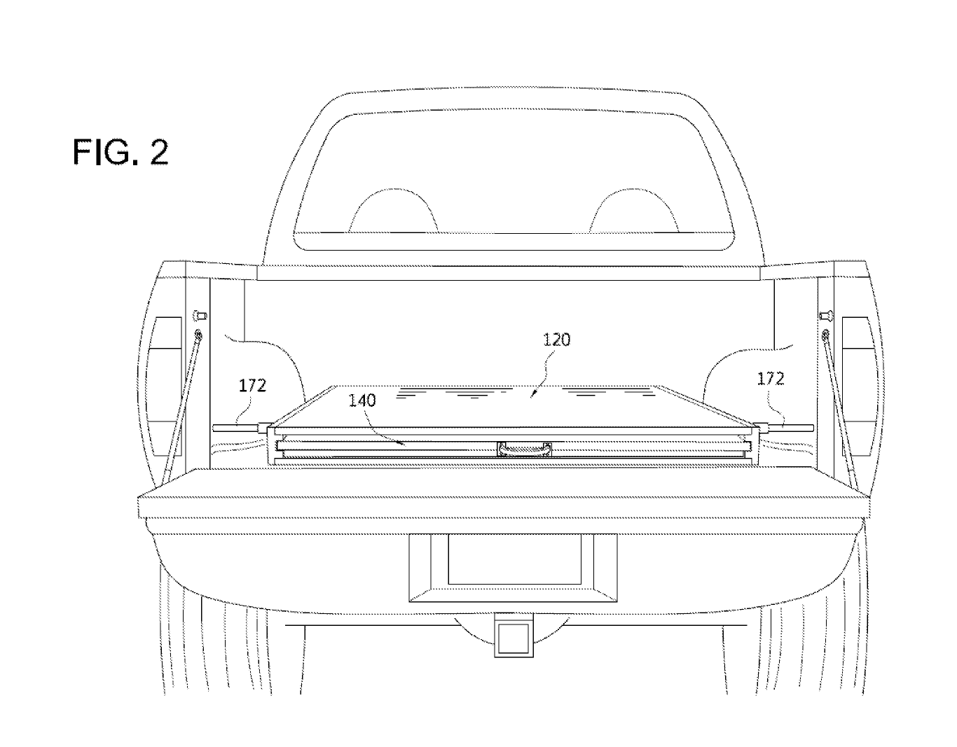

Exemplary FIG. 2 may depict an embodiment of a tool for selective attachment to a vehicle with a table in a stowed position.

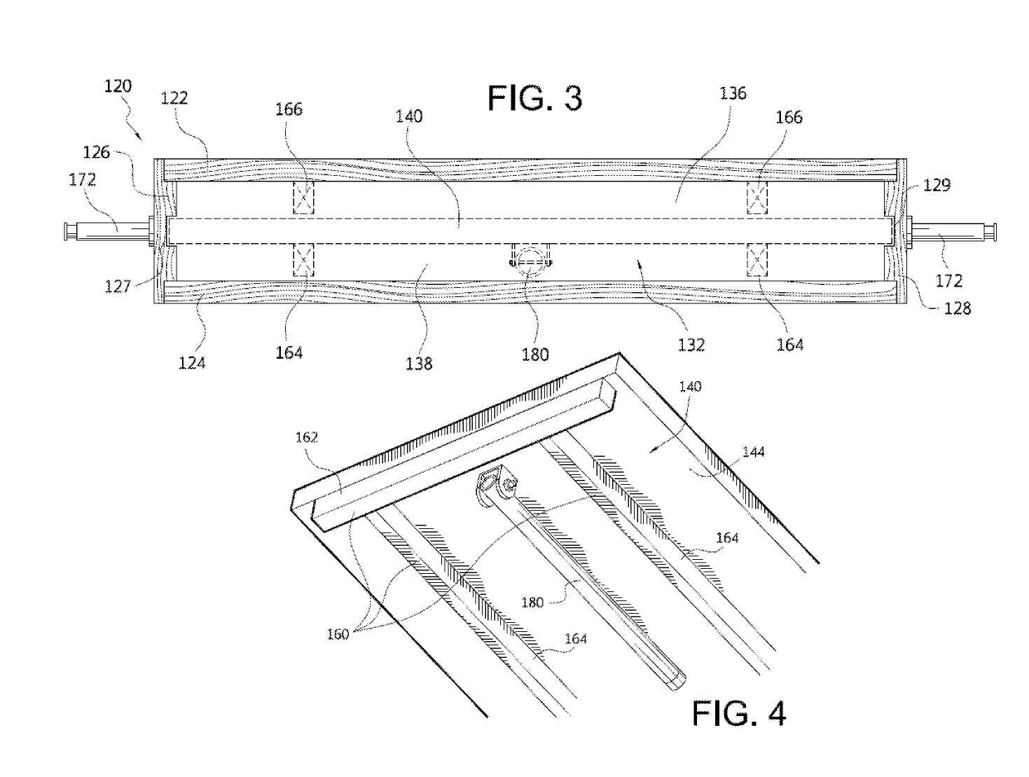

Exemplary FIG. 3 may depict a cross-sectional view of a shell for housing a table.

Exemplary FIG. 4 may depict a bottom perspective of a table.

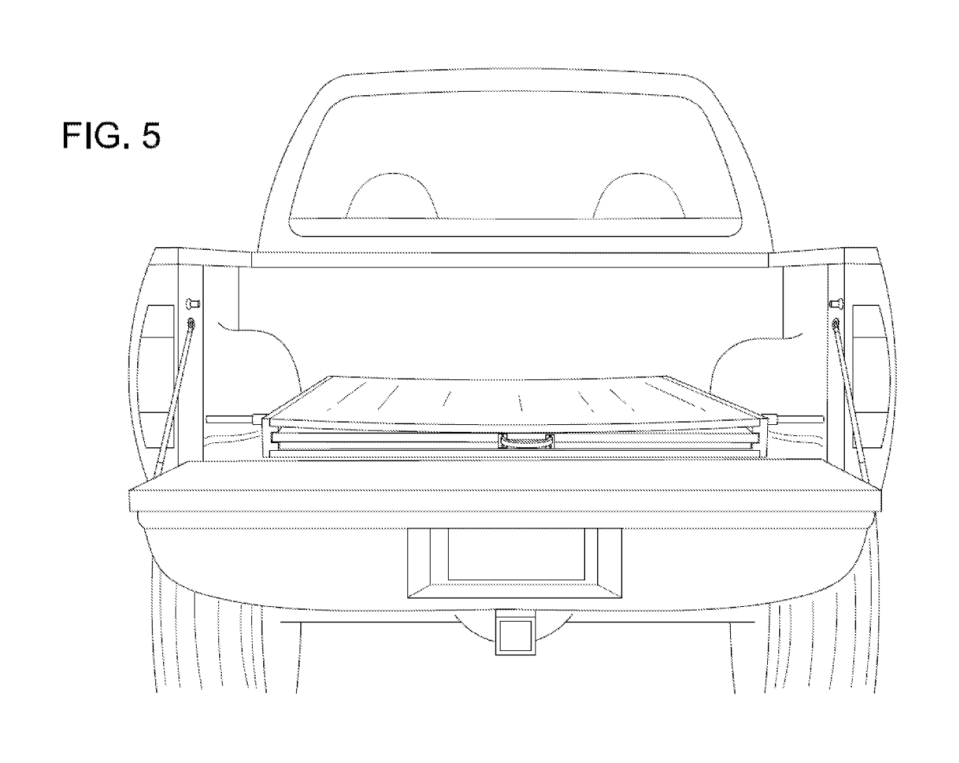

Exemplary FIG. 5 may depict another embodiment of a tool for selective attachment to a vehicle.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a tool for selective attachment to a vehicle may be provided. The tool 100 and components thereof may be made substantially of a durable, rigid, or semi-rigid material. Alternatively, the tool 100 and components thereof may be made from a substantially flexible material. The tool 100 and components thereof may be made from wood, plastics, polymers, metals and alloys, ceramics or combinations thereof

As may be depicted in exemplary FIGS. 1 and 2, the tool may be generally referred to with reference numeral 100. The tool may include a shell 120, a table 140, one or more support members 160, and one or more legs 180. The table 140 may be slidable relative to the shell 120 between an extended position as may be depicted in exemplary FIG. 1 and a stowed position as may be depicted in exemplary FIG. 2.

As may be depicted in exemplary FIG. 3, the shell 120 may define a substantially rectangular cross section. The shell 120 may include a top panel 122, a bottom panel 124, a first side panel 126 and a second side panel 128. The shell 120 may further include a back panel 130.

A cavity 132 having an opening 134 opposite the rear panel 130 may be provided between the top panel 122, the bottom panel 124, the first side panel 126 and the second side panel 128. The first side panel 126 may define a first groove 127 extending along the length of the first side panel 126. The second side panel 128 may define a second groove 129 extending along the length of the second side panel 128.

The table 140 may have a top surface 142, a bottom surface 144, a front edge 146, a rear edge 148, first side edge 150, and a second side edge 152. Each of the top surface 142, the bottom surface 144, the front edge 146, the rear edge 148, the first side edge 150 and the second side edge 152 may be substantially planar. The table 140 may be at least partially disposed within the cavity 132 and slidable relative to the shell 120. The first side edge 150 may be disposed within the first groove 127 of the first side panel 126, and the second side edge 152 may be disposed within the second groove 129 of the second side panel 128. The shell 120 and the table 140 may thus have tongue-and-groove configuration whereby the table 120 may be configured to slide smoothly relative to the shell 140. This arrangement may advantageously provide a slidable joint that is free of additional components such as wheels, tracks, bolts, brackets, or the like. Reducing the number of additional components provided may improve the capacity of the portable load supporting vehicle table to reliably support heavy cargo loads. Alternatively, other slidable joint arrangements may be provided between the shell 120 and the table 140 as will be understood by those skilled in the art.

The table 140 may be partially disposed within the cavity 132 of the shell 120 such that a portion of the table 140 protrudes from the opening 134 of the cavity 132, thereby exposing at least a portion of the top surface 142 of the table 140. Alternatively, the table 140 may be fully disposed within the cavity 132 such that no portion of the table 140 extends beyond the opening 134 of the cavity 134. The table 140 may divide the cavity 132 into a top portion 136 above the top surface 142 of the table 140 and a bottom portion 138 below the bottom surface 144 of the table 140. The table 140 may substantially bisect the cavity 132 such that the top portion 136 is substantially equal in vertical extension to the bottom portion 138.

As may be depicted in exemplary FIG. 4, one or more support members 160 may be coupled to the bottom surface 144 of the table 140. The support members 160 may include a front ridge member 162 that extends along the front edge 146 of the table 140. The front ridge member 162 may be sized such that it has a vertical extension that is substantially equal to or slightly less than the vertical extension of the bottom portion 138 of the cavity 132. In other words, the front ridge member 162 may be disposed such that it substantially closes the portion of the opening 134 that is below the table 140 when the table 140 is disposed entirely within the cavity 132.

The support members 160 may further include one or more support beams 164 coupled to the bottom surface 144 of the table 140. One or more support beams 164 may extend longitudinally, horizontally or in a diagonal direction along the bottom surface 144 of the table 140. Additionally, there may be a combination of longitudinal, horizontal and/or diagonal support beams 164 disposed along the bottom surface 144 of the table 140. Each support beam 164 may be sized such that it has a vertical extension that is substantially equal to or slightly less than the vertical extension of the bottom portion 138 of the cavity 132. So configured, each support beam 164 may have a vertical extension that is substantially equal to a vertical extension of the ridge member 162.

One or more legs 180 may be provided. Each leg 180 may include an elongate member that extends along a longitudinal axis. Each leg 180 may be pivotably coupled to the bottom surface 144 of the table 140. The pivotable connections may be provided by joint structures such as ball and socket joints, saddle joints, hinge joints, pivot joints, living hinges, or the like. Each leg 180 may be pivotable between a deployed position wherein the longitudinal axis of the leg 180 extends substantially perpendicular to the bottom surface 144 of the table 140, and a stowed position wherein the longitudinal axis of the leg 180 extends substantially parallel to the bottom surface 144 of the table 140. Each leg 180 may be stowed in a hollow cutout underneath the table 140 wherein the hollow cutout may be sized and shaped to match the dimensions of the leg 180. Rather than being pivotably coupled to the bottom surface 144 of the table 140, each leg 180 may alternatively be freely stowed in the hollow cutout such that it may be removed and snapped into a receiving portion in the bottom surface 144 that is configured to hold the leg 180 in a deployed position.

Each leg 180 may have a vertical extension in the stowed position that is less than a vertical extension of the bottom portion 138 of the cavity 132. Each leg 180 may further have a vertical extension in the stowed position that is less than the vertical extension of each of the support members 160. In this manner, the one or more legs 180 may be stowed within the bottom portion 138 of the cavity 132 such that they may avoid contact with either the bottom surface 144 of the table 140 and the top surface of the bottom panel 124 of the shell 120. Furthermore, any load applied to the table 140 may be transferred to the bottom panel 124 via the support members 160 without being transmitted to the one or more legs 180 or components thereof. This configuration may advantageously prevent damage to the legs 180 and components thereof when cargo may be transported in the vehicle.

The shell 120 may include an attachment mechanism 170 by which the shell may be attached to a vehicle 10. The attachment mechanism 170 may include a number of arm members 172. Each arm member 172 may be disposed on a side panel 126, 128 such that the arm member 172 extends perpendicular to a plane of the side panel 126, 128 to which the arm member 172 is attached. Each arm member 172 may be pivotably coupled to the respective side panel 126, 128 such that the arm member 172 may be stowed in an associated cutout disposed in the respective side panel 126, 128 when the arm member 172 is not in use.

Each arm member 172 may be extendable along its length such that the arm member 172 may selectively contact and engage a wall of a vehicle 10. A first pair 174 of arm members 172 may be provided such that the arm members 172 of the first pair 174 may be oppositely disposed along a common axis that may extend horizontally across the shell 120. The first pair 174 of arm members 172 may be positioned to engage a portion of a vehicle 10 that is anterior to a wheel well 12 of the vehicle 10. A second pair 176 of arm members 172 may be positioned to engage a portion of a vehicle 10 that is posterior to a wheel well 12 of the vehicle. Additional pairs of arm members 172 may be provided to further secure the shell 120 to the vehicle 10 as will be understood to those skilled in the art. Alternatively, an attachment mechanism 170 may be provided as any conventional attachment mechanism such as a mounting bracket, bolts, ties, adhesives, pressure contact, or the like.

Exemplary FIG. 5 may depict an embodiment wherein the tool 100 may provide an apparatus for reliably supporting cargo provided in the vehicle. The top panel 122 of the shell 120 may be provided such that it is sufficiently flexible that the top panel 122 may flex so that the bottom surface of the top panel 122 may contact the top surface 142 of the table 140 when a cargo load is disposed on top of the tool 100. So configured, at least a portion of the weight of the cargo load applied to the top panel 122 may be transferred directly to the table 140. Alternatively, as shown in exemplary FIG. 3, one or more support ribs 166 may be disposed along the bottom surface of the top panel 122 such that when the top panel 122 flexes under a load, the ribs 166 may directly contact the top surface 142 of the table 140.

In turn, the table 140 may transfer all or a portion of the weight applied to the table 140 directly to the support beams 160 that are coupled to the bottom surface 144 of the table 140. The support beams 160 may be sized such that the support beams 160 have a vertical extension that is substantially equal to or slightly less than a vertical extension of the bottom portion 138 of the cavity 132. So configured, when a cargo load is applied to the top panel 122 of the shell 120 and transferred to the table 140, the table 140 may flex a small amount such that the support beams 160 may directly contact the bottom panel 124 of the shell 120. Thus, all or a portion of the weight applied to the support beams 160 may in turn be transferred directly to the bottom panel 124 of the shell 120, which in turn may transfer all or a portion of the weight directly to a portion of a vehicle such as a floor, a wall, a securing device, or the like.

In this manner, the weight of a cargo load that may be disposed on top of the shell 120 may be transferred from the top panel 122, through the table 140, through the support beams 160, through the bottom panel 124 to the vehicle. The weight may be transferred to the vehicle without applying substantial force to any joints, legs, movable components, fragile components, or the like. This configuration may allow the tool 100 to reliably support cargo loads without incurring damage, thereby maximizing the load-supporting function of the tool 100 while minimizing maintenance and repairs.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A tool for selective attachment to a vehicle comprising:
a shell having a substantially rectangular cross-section, wherein the shell comprises a top panel, a bottom panel, a first side panel, and a second side panel;
at least one support member coupled to the bottom surface of the top panel of the shell;
a cavity defined between the top panel, the bottom panel, the first panel and the second panel; and
a table comprising a substantially planar top surface, wherein the table is at least partially disposed within the cavity and is slidable relative to the cavity.

2. A tool as recited in claim 1, wherein the side panels define grooves running along the lengths of said side panels, and the table has a first edge that is disposed in the groove of the first side panel and a second edge that is disposed in the groove of the second side panel.

3. A tool as recited in claim 2, further comprising a ridge member extending along a front edge of the table, wherein the ridge is disposed such that when the table is fully disposed within the shell, the ridge substantially closes a portion of the opening of the cavity that is disposed below the table.

4. A tool as recited in claim 3, wherein at least one leg is attached to a bottom surface of the table, the at least one leg comprising an elongate member having a longitudinal axis.

5. A tool as recited in claim 4, wherein the at least one leg is pivotably coupled to the bottom surface of the table such that the leg may be pivoted between a stowed position wherein longitudinal axis extends substantially parallel to the bottom surface of the table, and a deployed position wherein the longitudinal axis extends substantially perpendicular to the bottom surface of the table.

6. A tool as recited in claim 5, wherein the at least one leg has a width defined perpendicular to the elongate axis such that the width extends vertically between the bottom surface of the table and the bottom panel of the shell when the leg is in the stowed position, and further wherein the width of the leg is less than a vertical extension of the downwardly extending ridge.

7. A tool as recited in claim 6, wherein the leg is telescoping such that the leg is configured to be extended along its longitudinal axis.

8. A tool as recited in claim 7, wherein the table comprises at least one support member that is coupled to the bottom surface of the table and extends substantially parallel to the at least one leg when the leg is in the stowed position.

9. A tool as recited in claim 8, wherein the at least one support member has a vertical extension that is substantially equal to the vertical extension of the downwardly extending ridge.

10. A tool as recited in claim 9, further comprising:
a first arm member coupled to an outer surface of the first side panel of the shell and extending perpendicular to a plane of the outer surface of the first side panel; and
a second arm member coupled to an outer surface of the second side panel of the shell and extending perpendicular to a plane of the outer surface of the second side panel;
wherein the first and second arm members are configured to axially extend to engage one or more walls of a vehicle.

11. A tool as recited in claim 10, wherein the first and second arm members comprise a first pair of oppositely disposed arm members that share a first common longitudinal axis.

12. A tool as recited in claim 11, further comprising a second pair of oppositely disposed arm members that share a second common longitudinal axis that is different from the first common longitudinal axis, wherein the first pair of oppositely disposed arm members is configured to secure the shell relative to a portion of a vehicle that is anterior to a wheel well of the vehicle, and the second pair of oppositely disposed arm members is configured to secure the shell to a portion of the vehicle that is posterior to a wheel well of the vehicle.

13. A tool as recited in claim 2, wherein the tool comprises a durable, semi-rigid material.

14. A tool as recited in claim 13, wherein the tool comprises wood.

15. A tool as recited in claim 13, wherein the tool comprises plastic.

16. A tool as recited in claim 13, wherein the top panel of the shell is configured to flex such that a bottom surface of the top panel directly contacts the top surface of the table.

17. A tool as recited in claim 16, wherein when a load is applied to the top panel, at least a portion of the weight of the load is directly transferred to the table via the direct contact between the bottom surface of the top panel and the top surface of the table.

18. A tool for selective attachment to a vehicle comprising:
a shell having a substantially rectangular cross-section, wherein the shell comprises a top panel, a bottom panel, a first side panel, and a second side panel;
a cavity defined between the top panel, the bottom panel, the first panel and the second panel;
a table comprising a substantially planar top surface, wherein the table is at least partially disposed within the cavity and is slidable relative to the cavity;
at least one support member coupled to the bottom surface of the table;
at least one support member coupled to the bottom surface of the top panel of the shell;
wherein the top panel of the shell is configured to flex such that a bottom surface of the top panel directly contacts the top surface of the table, and when a load is applied to the top panel, at least a portion of the weight of the load is directly transferred to the table via the direct contact between the bottom surface of the top panel and the top surface of the table.

19. A tool as recited in claim 18, further comprising:
at least one leg comprising an elongate member having a longitudinal axis, the at least one leg being pivotably coupled to a bottom surface of the table such that the at least one leg may be pivoted between a stowed position wherein longitudinal axis extends substantially parallel to the bottom surface of the table, and a deployed position wherein the longitudinal axis extends substantially perpendicular to the bottom surface of the table;
wherein the at least one support member has a vertical extension that is greater than a vertical extension of the at least one leg when the at least one leg is in the stowed position.

20. A tool as recited in claim 18, wherein at least a portion of the weight of the load is further transferred from the table to the at least one support member, and from the at least one support member to the bottom panel of the shell.

21. A tool as recited in claim 1, wherein the top panel of the shell is configured to flex such that a bottom surface of said at least one support member contacts the top surface of the table without the application of a weighted load.

22. A tool as recited in claim 3, wherein the ridge member sits flush with the bottom panel of the shell.

23. A tool as recited in claim 22, wherein when a load is applied to the top panel, at least a portion of the weight of the load is directly transferred to the bottom panel of the shell via direct contact with the ridge member.

24. A tool as recited in claim 2, wherein the first edge disposed in the groove of the first side panel and the second edge disposed in the groove of the second side panel facilitate selective translation of the table relative to the shell without the use of additional components.
